(19) United States
(12) Patent Application Publication
(10) Pub. No.: US 2026/0225327 A1
(43) Pub. Date: Aug. 6, 2026

(54) METHOD FOR MANUFACTURING COMPOSITE MATERIALS AND MOLD FOR THE SAME

(71) Applicant: GLORY WHEEL ENTERPRISE CO., LTD., Taichung City (TW)

(72) Inventor: CHIEN-HAO LEE, Taichung City (TW)

(21) Appl. No.: 19/047,352

(22) Filed: Feb. 6, 2025

(51) Int. Cl. B29C 70/30; B29C 33/02; B29C 33/38; B29K 307/04; B29L 31/30

(52) U.S. Cl. CPC B29C 70/30; B29C 33/02; B29C 33/3857; B29K 2307/04; B29L 2031/3091

(57) ABSTRACT

A method for manufacturing composite materials including the following steps: preparing an inner mold, wherein the inner mold is hollow, includes an outer surface, and is made of a two-phase material that has the ability to transition between at least two phases, with the two phases including at least a liquid phase and a solid phase, and transitioning from solid phase to liquid phase under phase-change conditions, wrapping the outer surface of the inner mold with a fiber-reinforced material by repeatedly winding or attaching the carbon fiber-reinforced material onto the outer surface, applying a forming temperature and forming pressure to the fiber-reinforced material, and removing the inner mold.

### FIELD OF INVENTION

The present invention relates to a method and a mold for manufacturing composite materials.

### BACKGROUND OF THE INVENTION

Conventional carbon fiber products, particularly composite components such as tubular or cavity structures requiring structural strength, are generally manufactured by forming a shaping cavity within a mold. Carbon fiber reinforced materials are applied to the interior of the shaping cavity and followed by film sealing, bag inflation, and curing to maintain structural integrity.

However, traditional manufacturing methods encounter significant challenges. The use of bag inflation to shape the internal space often results in difficulties in controlling the localized structural strength and leading to the formation of wrinkles. Such wrinkles increase the overall weight of the product and may introduce initial defects that compromise the structural reliability.

### SUMMARY OF THE INVENTION

To overcome the technical issues of internal wrinkles or difficulties in process control in carbon fiber manufacturing, this present invention discloses a method for manufacturing composite materials, comprising steps of: preparing an inner mold, wherein the inner mold is hollow and includes an outer surface, and the inner mold is made of a two-phase material, wherein the two-phase material is able to transition between at least two phases under phase-change conditions, with the two phases comprising at least a liquid phase and a solid phase; wrapping the outer surface of the inner mold with a carbon fiber-reinforced material by winding or attaching the carbon fiber-reinforced material onto the outer surface; applying a forming temperature and a forming pressure to the carbon fiber-reinforced material; and removing the inner mold.

Wherein, the forming temperature comprises an external temperature and an internal temperature, wherein the internal temperature is provided by an internal heat source placed inside the inner mold, heating the entire or partial surface of the inner mold.

Wherein, forming the inner mold comprises steps of: making a preform; making a reverse mold from the preform; introducing the flowable two-phase material into a cavity of the reverse mold and applying a curing condition during a multi-axis rotation process to cure the two-phase material on an inner surface of the reverse mold; and repeating the previous step to increase the thickness of the cured two-phase material within the reverse mold on the inner surface.

Wherein, the inner mold is sealed and hollow.

Wherein, the phase transition condition comprises water-soluble, heat-soluble, or photo-decomposable, and the material of the inner mold comprises polyethylene glycol, modified polyethylene glycol, wax, metal, or a mixture thereof.

This present invention also provides a mold for manufacturing composite materials, wherein the mold is hollow, and the mold comprises a two-phase material, wherein the two-phase material is able to transition between at least two phases under phase-change conditions, with the two phases comprising at least a liquid phase and a solid phase.

Wherein, the mold comprises two two-phase materials, and each of the two-phase materials possesses different phase-change condition.

Wherein, an internal heat source is placed inside the mold heating an inner surface of the mold.

Wherein, the phase transition condition comprises water-soluble, heat-soluble, or photo-decomposable, and the material of the inner mold comprises polyethylene glycol, modified polyethylene glycol, wax, metal, or a mixture thereof.

Based on the aforementioned description, the present invention has the following advantages:
1. The inner mold proposed by the present invention offers the advantage of greater precision compared to traditional carbon fiber bladder molding processes, addressing the technical issue of folds forming inside the tube during conventional bladder molding, which adversely affects weight and structural strength.
2. The strength-adjusting structure on the surface of the inner mold proposed by the present invention selectively enables specific areas to have relatively thicker fiber coverage, thereby enhancing the localized reinforcement effect of the final product. By predefining the reinforcement areas, the structural strength in these regions is fully ensured while maintaining the most precise and minimal material usage, achieving an unexpected result that is difficult to accomplish with existing technologies.
3. The frame of the embedded tubing or wire can integrate wires or reserve wire channels during the frame manufacturing process in accordance with present invention. This not only solves the technical problem of time-wasting tube threading that is prone to failure in conventional frame manufacturing, but also makes the overall structure of the frame lighter and stronger.
4. The internal heat source in accordance with present invention can locally heat the carbon fiber from the inside out. With external heating and high pressure, the manufacturing method in accordance with present invention accelerates the overall manufacturing process, increasing production efficiency, reducing energy consumption, and lowering costs.
5. The strength-adjusting structure, especially in the tiered form, can be used to lay correct fiber orientations at specific locations as needed, enabling precise control of the strength in areas and parts that require reinforcement.

### BRIEF DESCRIPTION OF THE DRAWINGS

FIG. 1A is a partial schematic diagram of an embodiment of an inner mold in accordance with the present invention.

FIG. 1B is a cross-sectional side view of an embodiment of the inner mold in FIG. 1A.

FIG. 1C is a partial schematic diagram of a finished product in accordance with the present invention.

FIG. 1D is a cross-sectional side view of an embodiment of the finished product in FIG. 1C.

FIG. 2A is a partially enlarged side view of the inner mold in FIG. 1A.

FIG. 2B is an enlarged top view of the inner mold in FIG. 2A.

FIG. 2C is a cross-sectional side view of an embodiment of an inner mold in accordance with the present invention.

FIG. 2D is an operational cross-sectional side view of the inner mold in FIG. 2C during the manufacturing process in accordance with the present invention.??

FIG. 3A is a schematic diagram of an embodiment of a semi-finished product in accordance with the present invention.

FIG. 3B is a cross-sectional side view of an embodiment of the semi-finished product in FIG. 1A.

FIG. 4A is an operational schematic diagram of an embodiment of the manufacturing process in accordance with the present invention.

FIG. 4B is a cross-sectional side view of an embodiment of the manufacturing process in FIG. 1A.

FIG. 5 is an exploded perspective view of an embodiment of a reverse mold in accordance with the present invention.

FIG. 6 shows operational views of the inner mold made by the reverse mold in FIG. 5 with a manufacturing method in accordance with the present invention.

FIG. 7 is a schematic diagram of an embodiment of a finished product made by a mold with a manufacturing method in accordance with the present invention.

FIG. 8 shows operational end views of an embodiment of a manufacturing method in accordance with the present invention.

### DETAILED DESCRIPTION OF THE PREFERRED EMBODIMENTS

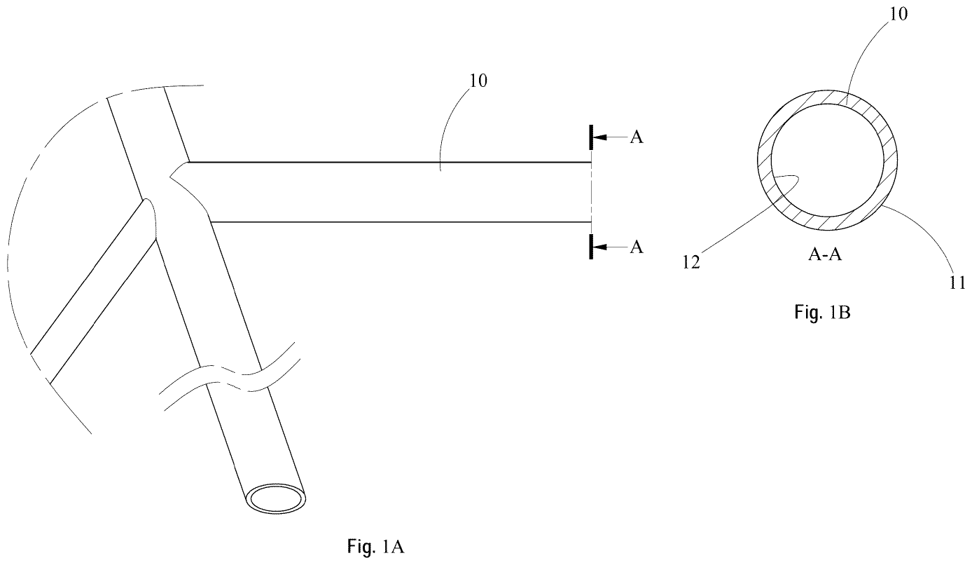

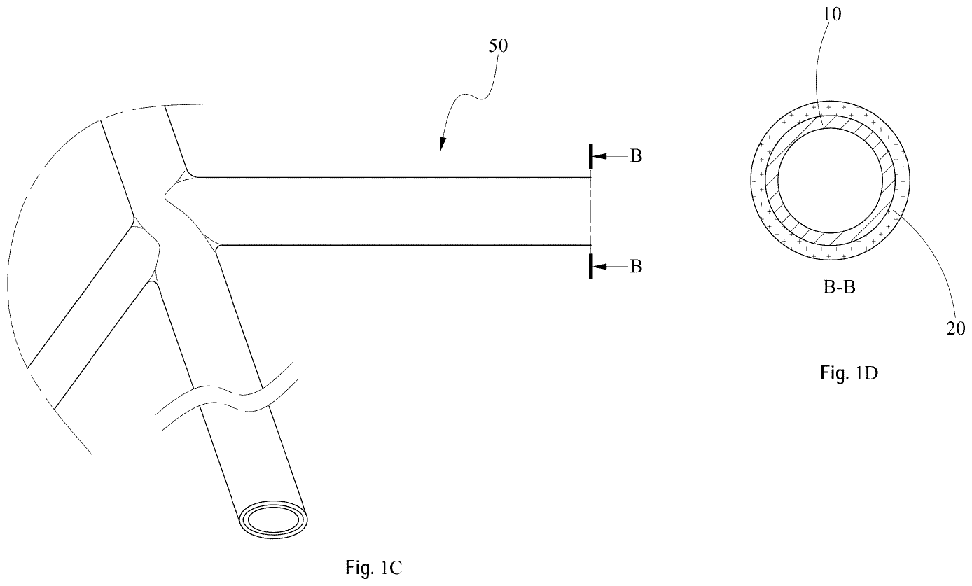

To address the limitations and technical problems of the prior art, the present invention proposes a method for manufacturing a composite material. With reference to FIG. 1A and FIG. 1B, the method comprises steps including:
STEP 1) Preparing an inner mold 10. The inner mold 10 is hollow. With reference to FIG. 1 and FIG. 8, the inner mold 10 include a two-phase material that has the ability to transition between at least two phases, such as a liquid phase and a solid phase. Under phase transfer conditions, the two-phase material of the inner mold 10 changes from the solid phase to the liquid phase, so the inner mold 10 can be transformed from a hollow structure to a liquid state with no fixed shape. The phase transfer conditions include, but are not limited to, water-soluble, heat-soluble, and photodegradable. Water-soluble materials include polyvinyl alcohol (PVA) or its derivatives, and heat-soluble compounds include wax or certain metals.

In addition, the inner mold 10 may include two or more dual-phase materials, and the phase transfer conditions for the two or more materials are different. For example, the inner mold 10 may include dual-phase materials comprising a water-soluble material and a heat-soluble material, each of which changes its phase under different conditions, such as exposure to water molecules, exposure to high temperature, or exposure to a combination of high temperature and water molecules.

As shown in FIGS. 1B, 2A to 2D, and 8, the inner mold 10 includes an outer surface 11, an inner surface 12, and optionally, a strength-adjusting structure 13, a guiding structure 14, and an embedded component 15. The outer surface 11 is used for attaching a carbon fiber material 20. The strength-adjusting structure 13 is a recessed or protruding region on the outer surface 11. The strength-adjusting structure 13 may be a gradual recess or a gradual protrusion. The gradual recess or protrusion represents a region on the outer surface 11 that gradually transitions into a recessed or protruding form respectively to form the gradual recess or protrusion. Preferably, the gradual recess or protrusion can be tiered, this means it can expand progressively at each tier, similar to contour lines that increase incrementally.

The guiding structure 14 is applied to guide the attachment process of the carbon fiber reinforced material 20. For instance, the guiding structure 14 may form guiding patterns, text, graphics, or embossed/debossed textures on the outer surface 11. The guiding structure 14 can indicate the type of fibers or the fiber orientation. For example, on each tier of the gradual recess within the recessed region, the guiding structure 14 may mark the fiber orientation and the number of layers of the carbon fiber reinforced material 20 used. This facilitates the wrapping process of the carbon fiber reinforced material 20 by aligning the carbon fiber reinforced material 20 with the guiding structure 14 to ensure proper correspondence with the strength-adjusting structure 13 or non-planar regions in terms of the number of layers and wrapping direction.

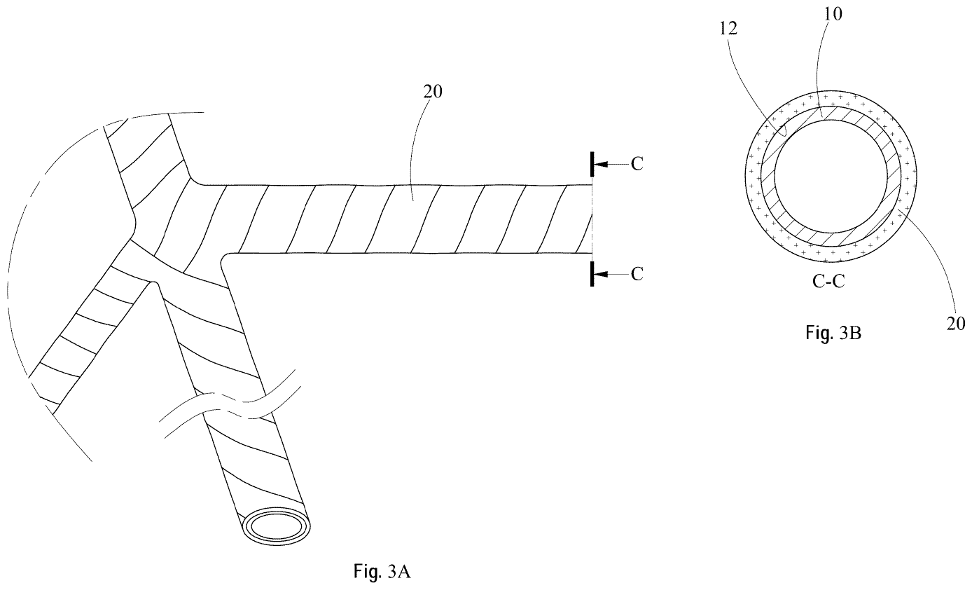

STEP 2) Wrapping carbon fiber materials around the inner mold 10: Repeatedly winding or attaching the carbon fiber reinforced material 20, such as prepreg carbon fiber fabric, unidirectional prepreg carbon fiber cloth (UD film/fabric), carbon fiber tape, or carbon fiber yarn, onto the outer surface 11. The carbon fiber yarn or carbon fiber tape may be wrapped around the outer surface 11 of the inner mold 10 using a winding method, as shown in FIGS. 3A and 3B. Prepreg carbon fiber fabric or unidirectional prepreg carbon fiber cloth may be applied to the outer surface 11 of the inner mold 10 through bonding, joint bonding, lamination, or layered stacking. Notably, carbon fibers with different properties may be selectively used and compositely attached to the outer surface 11 and the strength-adjusting structure 13 to enhance performance.

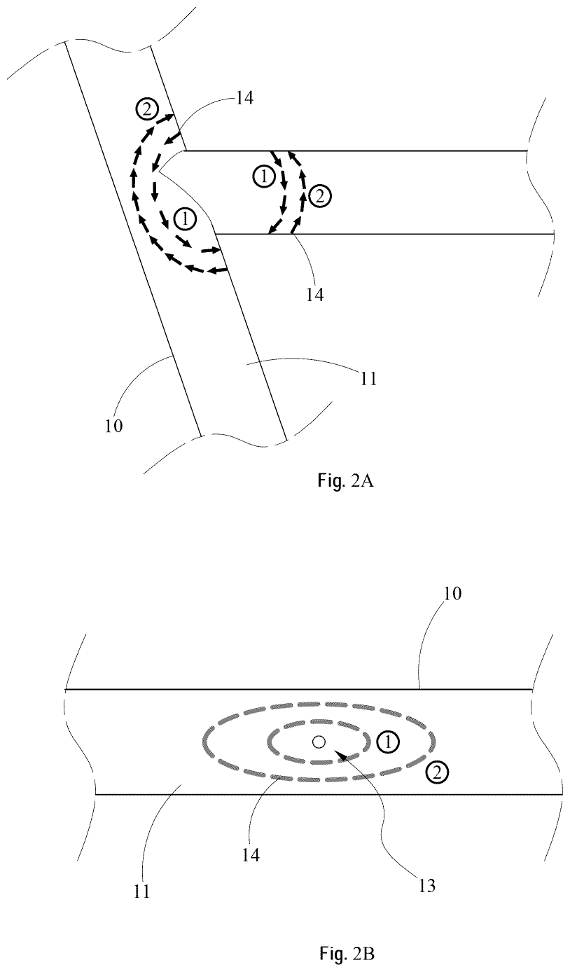

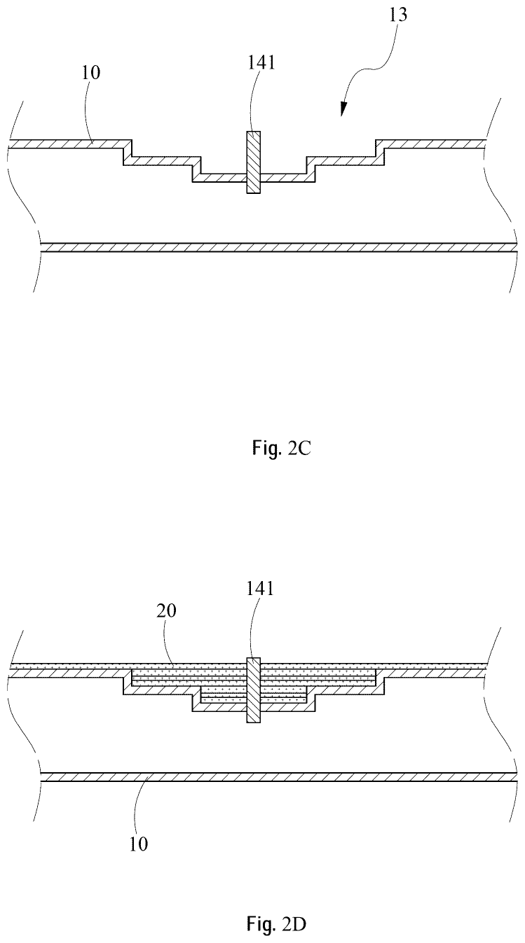

With reference to FIGS. 2A to 2D, 3A, and 3B, a formation method using the inner mold 10 to fabricate an electric bicycle carbon fiber frame 50 is described as an example. The inner mold 10 includes the strength-adjusting structure 13 with tiered, gradual recesses and the guiding structure 14 positioned along the strength-adjusting structure 13. The guiding structure 14 may also comprise a non-enclosing structure 141 located on the outer surface 11. In this embodiment, the non-enclosing structure 141 may be, for example, a cylindrical element positioned on the outer surface 11 (as shown in FIG. 2B). Furthermore, the non-enclosing structure 141 is a column that extends through the recessed region of the strength-adjusting structure 13. During the carbon fiber application process, the operator (e.g., production line personnel) can wrap the carbon fiber around the inner mold 10, particularly around the non-enclosing structure 141. Multiple layers of fiber cloth or fabric with varying strengths can be stacked within the recessed region. By following the guiding structure 14 and the strength-adjusting structure 13, the operator can apply the appropriate carbon fiber reinforced material 20 onto the strength-adjusting structure 13 and the outer surface 11. After completing the fabrication of the electric bicycle carbon fiber frame 50, an opening 51 corresponding to the non-enclosing structure 141 is formed in the surface of the frame.

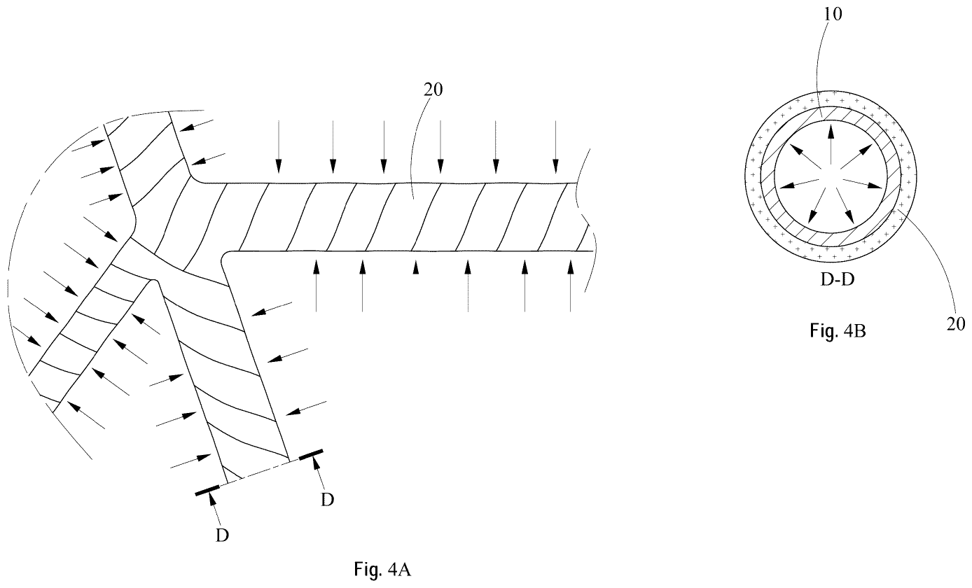

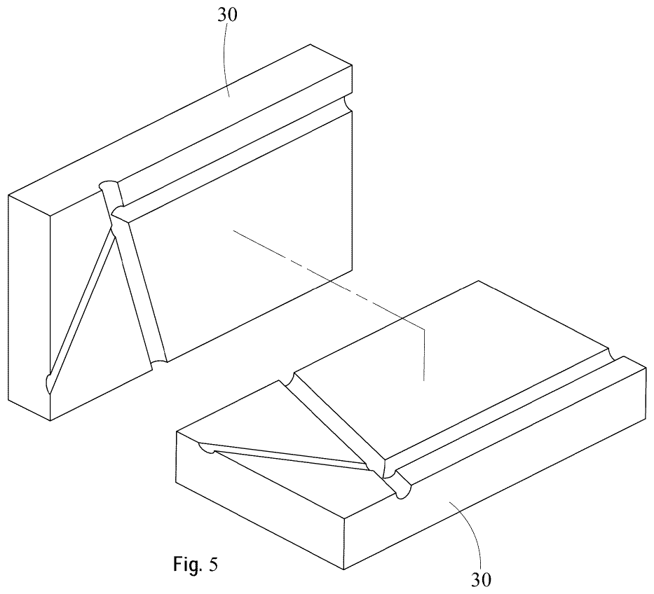

STEP 3) Applying a forming temperature and forming pressure to the carbon fiber reinforced material 20: Referring to FIGS. 4A and 4B, the inner mold 10 with the carbon fiber reinforced material 20 attached is subjected to the forming temperature and forming pressure. This process ensures that the fiber-to-resin ratio of the carbon fiber reinforced material 20 reaches a desired proportion, thereby the structural strength of the final product is enhanced. The forming temperature can be provided through various methods, including placing the inner mold 10, with the carbon fiber reinforced material 20 attached, inside a cavity where radiant heat or conductive heat supplies the temperature required for curing and forming. The forming pressure is applied to the carbon fiber reinforced material 20 to eliminate voids and excess resin between the laminated layers during the curing process.

The forming pressure can be applied using a vacuum bag combined with atmospheric pressure or by placing the entire inner mold 10 within a cavity capable of applying both temperature and pressure (e.g., an autoclave). This ensures that the forming pressure radially compresses the carbon fiber reinforced material 20 outward against the inner mold 10, enabling the carbon fiber reinforced material 20 to cure and form on the surface of the inner mold 10.

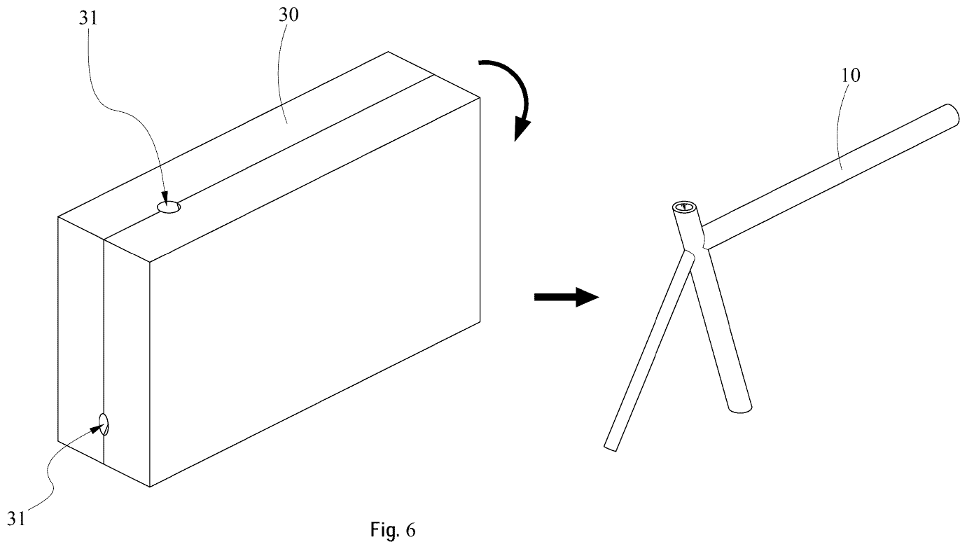

With reference to FIGS. 5 and 6, the method for forming the inner mold 10 comprises the following steps:
1) Fabricating a preform. The external appearance of the preform corresponds to the external appearance of the inner mold 10. The preform may be fabricated, for example, using 3D printing to design and produce the desired external appearance;
2) Producing a reverse mold 30 of the preform. The preform can be replicated into the reverse mold 30 using a silicone molding process, as shown in FIG. 5;
3) Pouring a flowable two-phase material into the reverse mold 30 of the preform and followed by applying a curing condition during a multi-axis rotation process to ensure the two-phase material cures on the inner surface of the cavity of the reverse mold 30. The curing condition may vary depending on the properties of the two-phase material and may include, for example, lowering the temperature or removing water molecules. The curing time within the reverse mold 30 can be adjusted based on the specific two-phase material used.

With the multi-axis rotation technique and controlled curing time, the two-phase material begins curing from the inner surface of the cavity of the reverse mold 30. Upon completion of the curing time, the uncured residual two-phase material is poured out through the mold opening 31 of the reverse mold 30 to enable the two-phase material to form a hollow structure conforming to the inner surface of the cavity of the reverse mold 30.

The selection of the curing time can simultaneously serve as a means to regulate the mold thickness of the inner mold 10 after its formation.

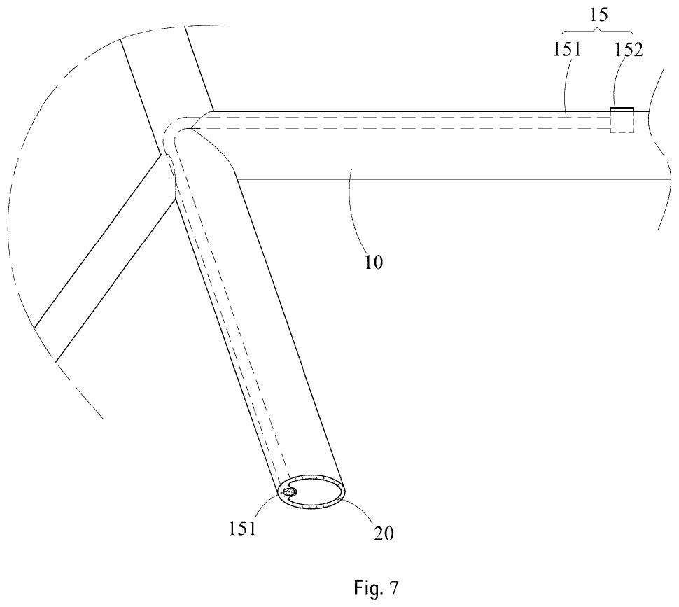

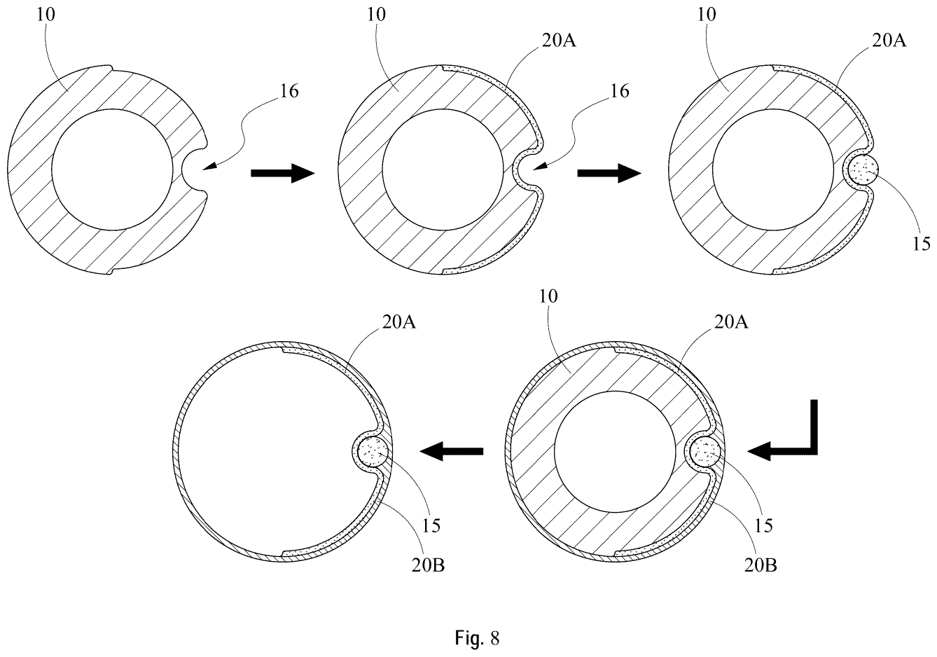

If necessary, Step 3 may be repeated to increase the thickness of the two-phase material cured within the reverse mold to form the hollow inner mold 10 as shown in FIG. 7. Preferably, the inner mold 10 is closed and hollow.

Furthermore, to reduce the overall curing and forming time, the inner mold 10 in accordance with the present invention may be further provided with an internal heat source enclosed within the solid phase of the hollow inner mold 10. This internal heat source heats the inner surface 12 of the inner mold 10 for significantly shortening the curing and forming time of the carbon fiber material. The internal heat source can apply targeted heating to specific areas, such as the recessed regions. By incorporating the internal heat source, it is possible to not only shorten the curing and forming time but also achieve numerous unexpected advantages, including improved overall curing and forming efficiency, reduced total energy consumption, enhanced product quality, and shorter waiting times.

STEP 4) Removing the inner mold 10: The inner mold 10 is transformed from the solid phase to the liquid phase and then is separated and removed from the cured carbon fiber material 20. The phase transition condition for the inner mold 10 varies depending on the type of the two-phase material used. For example, the inner mold 10 may be dissolved using water or liquefied through thermal melting.

The aforementioned embedded component 15 may be categorized into removable and non-removable types. Removable embedded components include items such as air bags or the two-phase materials. Non-removable embedded components may include pipelines or conduits with specific functions, such as brake cables, electrical wires, or hydraulic tubing. With reference to FIGS. 7 and 8, to integrate the embedded component 15 within the carbon fiber material 20, the inner mold 10 is designed to include a continuous trough 16. The continuous trough 16 extends continuously along the entire part or specific parts of the inner mold 10. In an embodiment of manufacturing the electric bicycle carbon fiber frame 50, the inner mold 10, corresponding to the frame's appearance, features a recessed wire trough as the continuous trough 16 on the outer surface 11 of an upper or lower tube section. This wire trough is dimensioned to accommodate the pipeline or pipelines of the embedded component 15, such as brake cables, electrical wires, or hydraulic tubing, with an inner diameter slightly larger than the pipeline, before the subsequent application of the carbon fiber material 20.

With reference to FIGS. 7 and 8, the present invention provides the inner mold 10 with the guiding structure 14 to determine the wrapping method of the carbon fiber material 20 and the method for arranging the embedded component 15. The guiding structure 14 integrates the embedded component 15 into the manufacturing process of the electric bicycle carbon fiber frame 50, which includes the following steps:
1) Using the inner mold 10 corresponding to the appearance of the electric bicycle carbon fiber frame 50. The outer surface 11 includes the strength-adjusting structure 13, and recessed region of the strength-adjusting structure 13 further contains the continuous trough 16, which is continuously recessed into the outer surface 11. The outer surface 11 may be provided with the guiding structure 14 to guide the method, position, and sequence for wrapping the carbon fiber reinforced material 20 with the inner mold 10 and placing the embedded component 15;
2) Adhering and wrapping at least one layer of a first carbon fiber reinforced material 20A onto the strength-adjusting structure 13 and within the continuous trough 16 of the outer surface 11;
3) Placing at least a portion of the embedded component 15, corresponding to the contours of the continuous trough 16, within the continuous trough 16;
4) Attaching and wrapping at least one layer of a second carbon fiber reinforced material 20B over the first carbon fiber reinforced material 20A, the embedded component 15, and the outer surface 11;
5) Applying the forming pressure and the forming temperature to the second carbon fiber reinforced material 20B and the first carbon fiber reinforced material 20A to enable second carbon fiber reinforced material 20B and the first carbon fiber reinforced material 20A to cure and form into the electric bicycle carbon fiber frame 50 integrated with a functional wire; and
6) Removing the inner mold 10.

Therefore, the electric bicycle carbon fiber frame 50 formed according to the aforementioned manufacturing method in accordance with this invention features a smooth outer surface 11 while the inner surface 12 includes inwardly protruding structures integrated with the embedded component 15, and an integrally formed electric bicycle carbon fiber frame 50 is achieved. The embedded component 15 is fully encapsulated by the carbon fiber reinforced material 20 (including the first carbon fiber reinforced material 20A and the second carbon fiber reinforced material 20B). The contact areas between the first carbon fiber reinforced material 20A and the second carbon fiber reinforced material 20B undergo co-pressing and co-curing to achieve further integration and solidification (as demonstrated in the present embodiment with the finished product of the electric bicycle carbon fiber frame 50). The embedded component 15 may include a removable airbag or the two-phase materials, or functional elements such as brake lines, the wires, or hydraulic pipelines.

Furthermore, taking the embedded component 15 as the wire 151 as an example, in one embodiment, a cylindrical non-enclosing structure 141 is provided at the location of the continuous trough 16. The description of the non-enclosing structure 141 has been detailed in the previous paragraphs and will not be redundantly explained here. In this manner, upon the completion of the electric bicycle carbon fiber frame 50, an opening 51 corresponding to the non-enclosing structure 141 can be formed in the surface and communicate with the continuous trough 16. Consequently, a quick-release terminal 152 connected to the wire 151 can be placed within the opening 51. This design enables the embedded component 15 to achieve rapid disassembly and integration through the quick-release terminal 152, while functionally connecting to a driving device.

The functional connection can be an electrical conductive connection or a hydraulic pipeline connection.

Furthermore, the embedded component 15 in accordance with the present invention may include two or more components and can incorporate mixed types of embedded components 15 with different properties. For instance, removable air bags can be used in combination with water-soluble embedded components 15. This allows for the production of hollow carbon fiber products with complex internal structures and multiple chambers, yet integrally formed. In addition, the non-enclosing structure 141 in the previous embodiment can be directly replaced by the embedded component 15 to enable the wire 151 and a drive terminal 152 to be co-formed within the electric bicycle carbon fiber frame 50 during its manufacturing process.

Based on the aforementioned description, the present invention has the following advantages:
1. The inner mold 10 proposed by the present invention offers the advantage of greater precision compared to traditional carbon fiber bladder molding processes to address the technical issue of folds forming inside the tube during conventional bladder molding, which adversely affects weight and structural strength.
2. The strength-adjusting structure 13 on the surface of the inner mold 10 proposed by the present invention selectively enables specific areas to have relatively thicker fiber coverage to enhance the localized reinforcement effect of the final product. By predefining the reinforcement areas, the structural strength in these regions is fully ensured while maintaining the most precise and minimal material usage to achieve an unexpected result that is difficult to accomplish with existing technologies.
3. The frame of the embedded tubing or wire can integrate wires or reserve wire channels during the frame manufacturing process in accordance with present invention. This not only solves the technical problem of time-wasting tube threading that is prone to failure in conventional frame manufacturing, but also makes the overall structure of the frame lighter and stronger.
4. The internal heat source in accordance with present invention can locally heat the carbon fiber from the inside out. With external heating and high pressure, the manufacturing method in accordance with present invention accelerates the overall manufacturing process, increases production efficiency, and reduces energy consumption, and manufacturing costs.
5. The strength-adjusting structure 13, especially in the tiered form, can be applied to lay correct fiber orientations at specific locations as needed to enable precise control of the strength in areas and parts that require reinforcement.

What is claimed is:

1. A method for manufacturing composite materials, comprising steps of:
preparing an inner mold, wherein the inner mold is hollow and includes an outer surface, and the inner mold is made of a two-phase material, wherein the two-phase material is able to transition between at least two phases under phase-change conditions, with the two phases comprising at least a liquid phase and a solid phase;
wrapping the outer surface of the inner mold with a carbon fiber-reinforced material by winding or attaching the carbon fiber-reinforced material onto the outer surface;
applying a forming temperature and a forming pressure to the carbon fiber-reinforced material; and
removing the inner mold.

2. The method for manufacturing composite materials according to claim 1, wherein the forming temperature comprises an external temperature and an internal temperature, wherein the internal temperature is provided by an internal heat source placed inside the inner mold to heat the entire or partial surface of the inner mold.

3. The method for manufacturing composite materials according to claim 1, wherein the step of forming the inner mold comprises steps of:
making a preform;
making a reverse mold from the preform;
introducing the flowable two-phase material into a cavity of the reverse mold and applying a curing condition during a multi-axis rotation process to cure the two-phase material on an inner surface of the reverse mold; and
repeating the previous step to increase the thickness of the cured two-phase material within the reverse mold on the inner surface.

4. The method for manufacturing composite materials according to claim 2, wherein the step of forming the inner mold comprises steps of:
making a preform;
making a reverse mold from the preform;
introducing the flowable two-phase material into a cavity of the reverse mold and applying a curing condition during a multi-axis rotation process to cure the two-phase material on an inner surface of the reverse mold; and
repeating the previous step to increase the thickness of the cured two-phase material within the reverse mold on the inner surface.

5. The method for manufacturing composite materials according to claim 3, wherein the inner mold is sealed and hollow.

6. The method for manufacturing composite materials according to claim 4, wherein the inner mold is sealed and hollow.

7. The method for manufacturing composite materials according to claim 1, wherein the phase transition condition comprises water-soluble, heat-soluble, or photo-decomposable, and the material of the inner mold comprises polyethylene glycol, modified polyethylene glycol, wax, metal, or a mixture thereof.

8. The method for manufacturing composite materials according to claim 2, wherein the phase transition condition comprises water-soluble, heat-soluble, or photo-decomposable, and the material of the inner mold comprises polyethylene glycol, modified polyethylene glycol, wax, metal, or a mixture thereof.

9. The method for manufacturing composite materials according to claim 3, wherein the phase transition condition comprises water-soluble, heat-soluble, or photo-decomposable, and the material of the inner mold comprises polyethylene glycol, modified polyethylene glycol, wax, metal, or a mixture thereof.

10. The method for manufacturing composite materials according to claim 4, wherein the phase transition condition comprises water-soluble, heat-soluble, or photo-decomposable, and the material of the inner mold comprises polyethylene glycol, modified polyethylene glycol, wax, metal, or a mixture thereof.

11. The method for manufacturing composite materials according to claim 5, wherein the phase transition condition comprises water-soluble, heat-soluble, or photo-decomposable, and the material of the inner mold comprises polyethylene glycol, modified polyethylene glycol, wax, metal, or a mixture thereof.

12. The method for manufacturing composite materials according to claim 6, wherein the phase transition condition comprises water-soluble, heat-soluble, or photo-decomposable, and the material of the inner mold comprises polyethylene glycol, modified polyethylene glycol, wax, metal, or a mixture thereof.

13. A mold for manufacturing composite materials, wherein the mold is hollow, and the mold comprises a two-phase material, wherein the two-phase material has an ability of transition between at least two phases under phase-change conditions, with the two phases comprising at least a liquid phase and a solid phase.

14. The mold for manufacturing composite materials according to claim 13, wherein the mold comprises two two-phase materials, and each of the two-phase materials possesses different phase-change condition.

15. The mold for manufacturing composite materials according to claim 13, wherein an internal heat source is placed inside the mold for heating an inner surface of the mold.

16. The mold for manufacturing composite materials according to claim 14, wherein an internal heat source is placed inside the mold for heating an inner surface of the mold.

17. The mold for manufacturing composite materials according to claim 13, wherein the phase transition condition comprises water-soluble, heat-soluble, or photo-decomposable, and the material of the inner mold comprises polyethylene glycol, modified polyethylene glycol, wax, metal, or a mixture thereof.

18. The mold for manufacturing composite materials according to claim 14, wherein the phase transition condition comprises water-soluble, heat-soluble, or photo-decomposable, and the material of the inner mold comprises polyethylene glycol, modified polyethylene glycol, wax, metal, or a mixture thereof.

19. The mold for manufacturing composite materials according to claim 15, wherein the phase transition condition comprises water-soluble, heat-soluble, or photo-decomposable, and the material of the inner mold comprises polyethylene glycol, modified polyethylene glycol, wax, metal, or a mixture thereof.

20. The mold for manufacturing composite materials according to claim 16, wherein the phase transition condition comprises water-soluble, heat-soluble, or photo-decomposable, and the material of the inner mold comprises polyethylene glycol, modified polyethylene glycol, wax, metal, or a mixture thereof.
